(19) United States
(12) Patent Application Publication
(10) Pub. No.: US 2025/0001354 A1
(43) Pub. Date: Jan. 2, 2025

(54) Method For Chemical Absorption And Recovery Of CO2 With Low Energy Consumption At Low Temperatures

(71) Applicant: Value Group B.V., Rotterdam (NL)

(72) Inventors: Christiaan Leo Evert NIJST, Den Haag (NL); Franciscus Johannes Maria SCHRAUWEN, Leidschendam (NL)

(73) Assignee: Value Group B.V., Rotterdam (NL)

(21) Appl. No.: 18/718,661

(22) PCT Filed: Dec. 15, 2022
(86) PCT No.: PCT/NL2022/050723

§ 371 Date: Jun. 11, 2024

(30) Foreign Application Priority Data
Dec. 16, 2021 (NL) 2030150

(51) Int. Cl. B01D 53/14; B01D 53/22

(52) U.S. Cl. CPC B01D 53/1475; B01D 53/1425; B01D 53/22; B01D 2252/204; B01D 2258/0283; B01D 2259/455

(57) ABSTRACT

A method for removing carbon dioxide (CO₂) from a gas is described. The method provides a sorbent liquid for the CO₂ in countercurrent flow with a gas stream comprising the CO₂ and absorbs the CO₂ in the sorbent liquid to obtain a gas with a reduced concentration of CO₂, and a sorbent liquid enriched with the absorbed CO₂. The absorbed CO₂ is stripped from the enriched sorbent liquid to obtain a regenerated sorbent liquid and CO₂-containing gas. The absorbing step a) is performed at a first facility provided in a first location and the sorbent liquid enriched with the absorbed CO₂ is then transported from the first facility to a second facility provided in a second location at a distance from the first location. The stripping step b) is performed at the second facility and at least 4 hours later than the absorbing step a). The stripping step b) is performed by a membrane separation system.

### TECHNICAL FIELD

The present invention concerns a method for removal of carbon dioxide (CO₂) from a gas stream using chemical solvents such as monoethanolamine (MEA) or diethanolamine (DEA). In particular, a method is provided to capture CO₂ from flue gas, to avoid CO₂ release to the atmosphere, which method uses chemical absorption and recovery of CO₂ with low energy consumption at low temperatures.

### BACKGROUND ART

A typical method of removing acid gases such as CO₂ from a gas stream involves using an absorber unit and a regenerator unit, supplemented with suitable accessory equipment. In the absorber unit, a down flowing amine solvent absorbs the acid gas such as CO₂ from an up flowing CO₂-containing gas stream to produce a gas stream that is essentially devoid of CO₂ and an amine solvent enriched with the absorbed acid gases. The resultant “rich” amine solvent is then routed into the regenerator unit, for instance embodied as a stripper provided with a reboiler, to produce regenerated or “lean” amine that is recycled for reuse in the absorber. The stripped overhead gas from the regenerator typically comprises a concentrated acid gas stream that is rich in CO₂. In this way, pure CO₂ may be recovered. The recovered CO2 may then be transported and stored in a suitable storage, for instance underground.

The above described known method involving absorption and recovery through stripping of CO₂ suffers from a relatively high energy consumption. As an example, the total amount of energy required is typically in the range of 3-4 GJ per ton of recovered CO₂. This may increase the amount of flue gas from which the CO₂ must be captured. The high energy input, needed to operate an integrated chemical absorber/stripper unit producing pure and pressurized CO₂, may be reduced by proper selection of the chemical solvent, its concentration, operating conditions, heat integration, and other. However, a significant part of the energy requirement cannot be reduced: recovery of CO₂ in pure form at increased pressure requires high stripper temperatures to release the chemically bound CO₂ from the solvent. This takes sensible heat, to heat up the solvent to stripper temperature of typically 120-130° C., and power for pumping and compression.

It is an aim of the present invention therefore to provide a method for capturing and recovering CO₂ present in flue gas, with a low energy consumption and at low temperatures.

### DISCLOSURE OF THE INVENTION

These and other aims are provided by a method in accordance with claim 1. The invention provides a method for removing carbon dioxide (CO₂) from a gas, for instance a flue gas, the method comprising:
a) providing a sorbent liquid for the CO₂, such as an amine solvent, in counter-current flow with a gas stream comprising the CO₂, and absorbing the CO₂ in the sorbent liquid so as to obtain a gas with a reduced concentration of CO₂, and a sorbent liquid enriched with the absorbed CO₂;
b) stripping the absorbed CO₂ from the enriched sorbent liquid so as to obtain a regenerated sorbent liquid and CO₂-containing gas,
wherein
   the absorbing step a) is performed at a first facility provided in a first location;
   the sorbent liquid enriched with the absorbed CO₂ is transported from the first facility to a second facility distinct from the first facility and provided in a second location at a distance from the first location;
   the stripping step b) is performed at the second facility with a membrane separation system and at least 4 hours later than the absorbing step a).

One element of the present invention is to use the loaded sorbent liquid as means for transport and storage of the absorbed CO₂. A further element of the invention is that the CO₂ is stripped from the sorbent liquid using a membrane separation system. The invented method enables storage or re-use of captured CO₂ in a; pure form with efficient transport, optional intermediate storage, low energy input at low temperature levels and low operating costs. Advantages of the invention are that capture of CO₂ and recovery/re-use of the CO₂ are uncoupled with regard to the rate of CO₂ capture, the rate of recovery, the capture-time and -location, and the recovery-time and -location.

The method provides a sorbent liquid for the CO₂, such as an amine solvent. Suitable amine solvents comprise for example diethanolamine (DEA), monoethanolamine (MEA), methyldiethanolamine (MDEA), diisopropanolamine (DIPA), and also aminoethoxyethanol (diglycolamine) (DGA). Other solvents and mixtures of solvents may also be used, optionally with additives and/or activators.

Another embodiment of the invention relates to a method wherein the sorbent liquid enriched with the absorbed CO₂ is stored at the first facility before transporting it to the second facility.

Yet another embodiment of the invention relates to a method wherein the sorbent liquid enriched with the absorbed CO₂ is stored at an intermediate location in between the first and second facilities.

According to yet another embodiment, a method is provided wherein the total time of transporting and storing the sorbent liquid enriched with the absorbed CO₂ is at least 4 hours.

The transport of the absorbed CO₂ may be performed by any method known in the art. According to a preferred embodiment, a method is provided wherein the sorbent liquid enriched with the absorbed CO₂ is transported at ambient pressure and/or ambient temperature, for instance by a road transport vehicle. Indeed, according to the invention, there is no need to compress and/or liquefy the recovered CO₂ for transport, as is typically done in the prior art method. This eliminates costs of compression equipment and energy consumption thereof. A further advantage is that there also is no need for dedicated CO₂ transportation (or storage) facilities such as pipelines and/or dedicated containment facilities. The CO₂ absorbed in the sorbent liquid may be handled by conventional facilities including lorries, barges, tank containers, warehousing, and the like.

A preferred embodiment in this context provides a method wherein direct pipe connections between the first facility and the second facility are lacking.

Another embodiment provides a method wherein a shortest distance between the first and the second facilities is at least 3 km, more preferably at least 5 km, and most preferably at least 10 km. With a shortest distance between a first location A and a second location B is meant in the context of the present disclosure the distance covered by a linear line connecting the two locations A and B.

The first and second facility may be stationary or non-stationary. An embodiment of choice relates to a method wherein the first facility comprises a sailing or harbored vessel and the second facility comprises a, preferably stationary, onshore facility. The shortest distance between the first location A of the vessel and the second location B of the on-shore facility is then defined as the distance covered by a linear line connecting the location A in which the vessel is harbored, and location B. One advantage of the invention relates to the possibility of adapting the recovery or stripping of the CO₂ according to the needs, conditions and specific requirements of an end-user, for instance situated at the second facility.

According to an embodiment of the invention, a method is provided wherein the stripping step b) is performed in a gas-liquid membrane separation system. Pure CO₂, released by the solvent, passes from the liquid side through the membrane to the gas side of the membrane unit, and is discharged. Release of the CO₂ from the solvent and passing through the membrane is enhanced by application of vacuum on the discharge (gas) side of the unit. This is beneficial for a shift of the solvent-CO₂ chemical equilibrium to release CO₂ to the gas phase. In conventional, integrated stripping according to the state of the art the CO₂ partial pressure may be within the range of 100-300 kPa.

Desorption of the CO₂ from the absorbent liquid or solvent in a membrane separation system is performed at mildly elevated (relative to ambient) temperature. This offers the possibility of saving sensible heat in comparison to a conventional integrated system according to the state of the art. A conventional stripper may typically operate at temperatures in the range of 110-140° C., which means that sensible heat may account for half of the total energy consumption of the process or more. The reduced temperature at which the membrane separation system is operated reduces, or even prevents, thermal degradation of the solvent. Also, there is no need for cooling water (or another coolant) required for the condenser in a conventional absorber/stripper.

The low stripping temperature may also reduce evaporation losses of the chemical solvent. The membrane system also prevents contamination of the recovered CO₂ with solvent.

In yet another embodiment of the invented method, at least 10 wt. % of the CO2 that is present in the gas stream comprising the CO2 is absorbed in the sorbent liquid during the absorbing step a), more preferably at least 30 wt. % CO2, and most preferably at least 50 wt. % CO2.

In another embodiment a method is provided wherein at most 90 wt. % of the CO2 that is present in the gas stream comprising the CO2 is absorbed in the sorbent liquid during the absorbing step a), more preferably at most 70 wt. % CO2, and most preferably at most 50 wt. % CO2.

It is explicitly mentioned that the embodiments disclosed in the present application may be combined in any possible combination of these embodiments, and that each separate embodiment may be the subject of a divisional application.

### BRIEF DESCRIPTION OF THE FIGURES

The above brief description, as well as other objects, features and advantages of the present invention will be more fully appreciated by reference to the following detailed description of a presently preferred, but nonetheless illustrative embodiment, when taken in conjunction with the accompanying drawing wherein:

FIG. 1 is a schematic representation of a method for CO₂ absorption from a gas stream comprising CO₂ in accordance with an embodiment of the invention;

FIG. 2 is a schematic representation of a method for CO₂ absorption from a gas stream comprising CO₂ in accordance with another embodiment of the invention;

FIG. 3 is a schematic representation of unloading/reloading sorbent liquid with a hose from a tank which is permanently installed aboard a vessel according to another embodiment of the invention;

FIG. 4 is a schematic representation of unloading/reloading of an exchangeable tank containing sorbent liquid at a harbor according to an embodiment of the invention;
and

FIG. 5 is a schematic representation of stripping absorbed CO₂ from the sorbent liquid with a gas-liquid membrane separation system according to an embodiment of the invention.

### DETAILED DISCLOSURE OF THE INVENTION

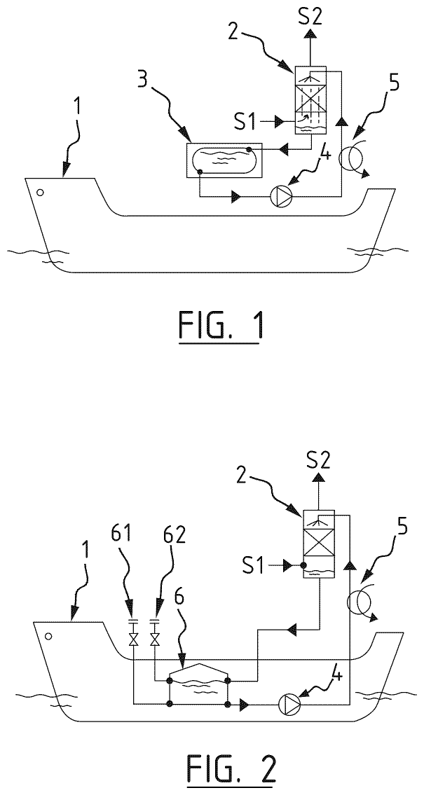

A scheme of the absorption system at a first off-shore facility, a vessel, is shown in FIG. 1. In the example shown CO2 is absorbed from flue gas, released by the propulsion system of a vessel 1, into a sorbent liquid. The sorbent liquid is contained in an exchangeable container; The components of the absorption system comprise a CO₂ absorber or scrubber 2, a sorbent liquid container 3, a pump 4 and an optional solvent cooler 5. Part or all of the flue gas from the ship propulsion system (stream S1) is carried through the CO₂ scrubber 2. Part or most of the CO₂ present in the stream S1 is absorbed by the sorbent liquid in the scrubber 2. The sorbent liquid is pumped from the exchangeable container 3 into the scrubber 2 by the pump 4, optionally cooled by the cooler 5. The flue gas from which CO₂ has been at least partly stripped is discharged as stream S2, for instance into the air. The sorbent liquid, enriched with CO₂ absorbed from the flue gas (S1), is drained back to the container 3. Container 3 may consist of multiple containers.

As known in the art, the scrubber 2 may be fitted with packing material for improvement of flue gas-sorbent liquid contact and CO₂ transfer, at the same time keeping pressure drop as low as possible. The scrubber 2 is preferably operated with counter-current flow of flue gas and sorbent liquid. The optional sorbent liquid cooler 5 removes absorption heat from the sorbent liquid and keeps sorbent liquid temperature low to maximize the CO₂ absorption capacity of the sorbent.

Operation of the absorption system is straightforward: the sorbent liquid is circulated through the scrubber 2 until saturation of the sorbent at operating conditions is achieved. Maximum CO₂ absorption capacity depends on type and concentration of the sorbent liquid chemical, on CO₂ content of the flue gas stream (S1), as well as on temperatures of the flue gas and the sorbent liquid.

As shown in FIG. 1, the first off-shore facility, a vessel 1, is provided with an exchangeable tank container 3 for the sorbent liquid. FIG. 2 shows an alternative first off-shore facility, a vessel 1, provided with a permanently installed container or tank 6 to contain the sorbent liquid. The sorbent liquid can be loaded via line 62, and can be unloaded via line 61, and can be transported by lorry or barge to on-shore storage or to an end-user.

Referring to FIG. 4, handling of a sorbent liquid tank container 3 at a harbour is shown. One or multiple containers 3 with fresh sorbent liquid with relatively low CO₂-content can be loaded from a lorry 8 by hoist 7 onto a vessel 1 or other off-shore facility in a harbour. One or multiple containers 3, with sorbent liquid enriched with CO₂, can be off-loaded in a harbour by hoist 7 and transported by lorry 8 or barge to on-shore storage or to an end-user.

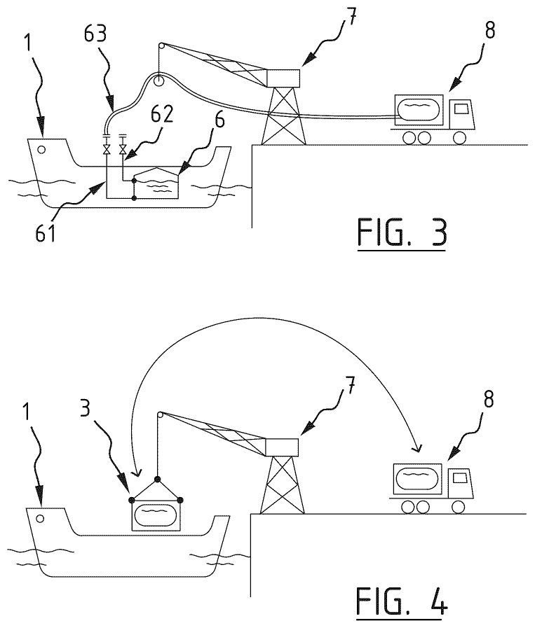

With reference to FIG. 3, pumping of sorbent liquid to (or from) a tank 6 permanently installed on a vessel 1 via hose 63 is schematically shown. Unloading occurs via a line 61, while filling the tank 3 may be carried out via line 62. In this embodiment, loading is to (or from) a lorry 8 with tank.

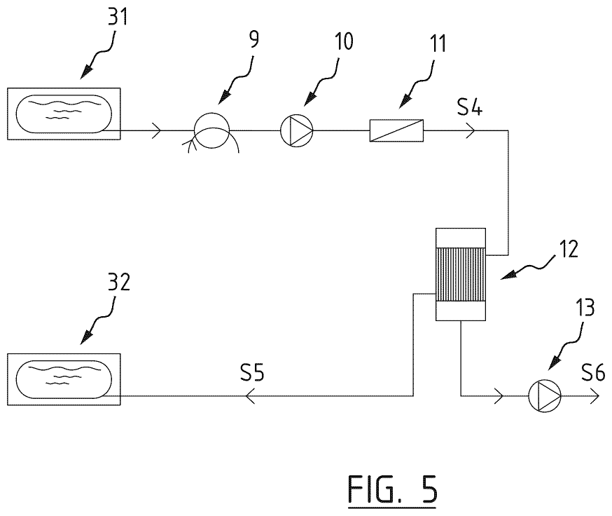

FIG. 5 shows an embodiment of a membrane separation system for recovery of CO₂ from chemical solvents. The system in particular comprises an exchangeable liquid container 31 provided with enriched sorbent liquid, an exchangeable liquid container 32 provided with regenerated or lean sorbent liquid, a solvent pump 10, an optional solvent heater 9, an optional filter 11, a membrane separation unit 12 and a vacuum pump 13. The enriched solvent (stream S4) is carried by pump 10 through the optional heater 9, the optional filter 11 and made to flow through the membrane separation unit 12. The conditions in the membrane separation unit 12 with regard to temperature, and pressures at liquid and gas side, are such that most of the CO₂ present in the enriched solvent (stream S4) is released to the gas side. The regenerated or lean solvent (stream S5) is discharged to the container with lean solvent 32. Pure recovered CO₂ is extracted from the membrane separation unit 12 by the vacuum pump 13 and discharged (stream S6) to the subsequent user. The low temperature heat supplied to solvent heater 9 can be provided from sustainable resources, for example solar or geothermal sources. The power input to pump 10 and vacuum pump 13 can also be provided from sustainable sources, for example wind or solar.

The stripping is preferably performed at mildly elevated temperature and at sub-ambient pressure at the gas-side. The method allows producing and discharging substantially pure CO₂.

1. Method for removing carbon dioxide (CO₂) from a gas, for instance a flue gas, the method comprising:
a) providing a sorbent liquid for the CO₂, such as an amine solvent, in counter-current flow with a gas stream comprising the CO₂ and absorbing the CO₂ in the sorbent liquid so as to obtain a gas with a reduced concentration of CO₂, and a sorbent liquid enriched with the absorbed CO₂;
b) stripping the absorbed CO₂ from the enriched sorbent liquid so as to obtain a regenerated sorbent liquid and CO₂-containing gas,
wherein
the absorbing step a) is performed at a first facility provided in a first location;
the sorbent liquid enriched with the absorbed CO₂ is transported from the first facility to a second facility distinct from the first facility and provided in a second location at a distance from the first location;
the stripping step b) is performed at the second facility with a membrane separation system and at least 4 hours later than the absorbing step a).
wherein the sorbent liquid enriched with the absorbed CO₂ is transported at ambient
pressure and/or ambient temperature, for instance by a road transport vehicle or barge.

2. Method as claimed in claim 1, wherein the sorbent liquid enriched with the absorbed CO₂ is stored at the first facility before transporting it to the second facility.

3. Method as claimed in claim 1, wherein the sorbent liquid enriched with the absorbed CO₂ is stored at an intermediate location in between the first and second facilities.

4. Method as claimed in claim 2, wherein the total time of transporting and storing the sorbent liquid enriched with the absorbed CO₂ is at least 4 hours.

5. Method as claimed in claim 1, wherein direct pipe connections between the first facility and the second facility are lacking.

6. Method as claimed in claim 1, wherein a shortest distance between the first and the second facilities is at least 3 km, more preferably at least 5 km, and most preferably at least 10 km.

7. Method as claimed in claim 1, wherein the first facility comprises a sailing or harbored vessel and the second facility comprises an onshore facility.

8. Method as claimed in claim 1, wherein the stripping step b) is performed with the membrane separation system at a temperature below 100° C., more preferably below 70° C., even more preferably below 40° C.

9. Method as claimed in claim 1, wherein at least 5 wt. % of the CO₂ that is present in the gas stream comprising the CO₂ is absorbed in the sorbent liquid during the absorbing step a), more preferably at least 10 wt. % CO₂, even more preferably at least 30 wt. % CO₂, and most preferably at least 50 wt. % CO₂.

10. Method as claimed in claim 1, wherein at most 90 wt. % of the CO₂ that is present in the gas stream comprising the CO₂ is absorbed in the sorbent liquid during the absorbing step a), more preferably at most 70 wt. % CO₂, and most preferably at most 50 wt. % CO₂.
